(19) United States
(12) Patent Application Publication
(10) Pub. No.: US 2019/0228501 A1
(43) Pub. Date: Jul. 25, 2019

(54) DISPLAY SYSTEM AND DISPLAY METHOD

(71) Applicant: INDUSTRIAL TECHNOLOGY RESEARCH INSTITUTE, Hsinchu (TW)

(72) Inventors: Hsin-Chang Chang, Hsinchu (TW); Chia-Sheng Chiang, Hsinchu (TW); Sheng-Yu Chuang, Hsinchu (TW); Chao-Chuang Mai, Hsinchu (TW)

(21) Appl. No.: 15/954,671

(22) Filed: Apr. 17, 2018

(30) Foreign Application Priority Data
Jan. 19, 2018 (TW) 107102040

(51) Int. Cl. G06T 3/40

(52) U.S. Cl. CPC G06T 3/40

(57) ABSTRACT

A display method includes: converting, by a fitting unit, a position information into a fitting parameter; constructing, by the fitting unit, a first pattern from the position information; constructing, by the fitting unit, a second pattern from the fitting parameter; calculating, by a calculation unit, an offset information between the first pattern and the second pattern; integrating, by an integration unit, the fitting parameter of the fitting unit and the offset information of the calculation unit into a reference information; and constructing, by the integration unit, a third pattern from the reference information. In a human-machine interface applying the display method, when a user enters an amount of tolerance into the human machine interface, the machining path represented by the third pattern is reproduced on the human machine interface. Thus, the display method can simplify operations of processing the machining path and reduce the load on the memory.

### CROSS-REFERENCE TO RELATED APPLICATION

The present disclosure is based on, and claims priority from, Taiwan Application Number 107102040 filed Jan. 19, 2018, the disclosure of which is hereby incorporated by reference herein in its entirety.

### BACKGROUND

### 1. Technical Field

The present disclosure relates to display systems, and, more particularly, to a display system and a display method for displaying computer numerical control (CNC) machining paths.

### 2. Description of Related Art

Computer Numerical Control (CNC) has been widely used in machine tools for machining, and digital controllers are usually equipped with the functionality to draw a machining path automatically.

The drawing function of a traditional digital controller requires the boundary of a path to be set before machining is executed. As such, the scale and display range of the screen of a human machine interface of the machine tool are pre-configured. However, the screen configuration cannot be adjusted until the machining process is finished. As a result, such drawing method will always record only the position of a previous point and that of a current point without keeping a record of each point in the process in order to save memory usage and improve drawing performance.

However, since a record of every point is not kept, the drawing unit cannot provide certain operations, such as shifting or scaling the screen showing a machining path.

Therefore, the industry has developed new drawing capabilities that allow the viewing canvas boundary of a machining path to be adjusted, shifted, scaled, etc. during or after the process, adding more values to the machining paths displayed by the human machine interface. When used for short periods of machining processes, these methods will not have severe impact, and the accumulated memory usage of the controller will not overburden the system.

However, in pursuing higher capacity utilization, a user often sets machines to work for long hours to raise the utilization rates. Moreover, parts having high values and requiring high precisions, such as aviation parts and dental parts, are more desirable, resulting in the processing times of machine tools on a production line to frequently exceed 24 hours. Under long hours of usage, the memory of the controller may be overloaded and the performance adversely impacted. For example, if the digital controller updates machining path position every 100 millisecond (ms) and the machine tool operates continuously for 24 hours, each axis of the three-axis will have 864,000 points of machining path (10×60×60×24=864,000). Thus, when re-drawing is carried out during or after the machining process, approximately 864,000 lines need to be drawn (since redrawing is done by connecting a line segment between two points) in order to display a machining path on the human machine interface. Furthermore, if a user continuously performs operations such as shifting, zoom-in, zoom-out, etc. on the human machine interface during or after the machining process, continuous redrawing is needed to display a machining path. This would require an even greater amount of computation data and cause the memory to overload.

In addition, the machining path drawn during or after the machining process is presented by multiple points, so the path may appear unsteady. Thus, it is difficult to determine the quality of the machining path, and in turn not possible to trace where the machine tool had done a poor job or had been unable to perform machining at all.

Therefore, there is a need for a display system that reduces computational resources and truly reflects the machining status of a machine tool to address the aforementioned issues in the prior art.

### SUMMARY OF THE DISCLOSURE

In view of the aforementioned shortcomings of the prior art, the present disclosure provides a display system applicable to a controller of a machine tool. The display system may include: a fitting unit for converting a position information into a fitting parameter, constructing a first pattern from the position information, and constructing a second pattern from the fitting parameter; a calculation unit for calculating an offset information between the first pattern and the second pattern; and an integration unit for integrating the fitting parameter from the fitting unit and the offset information from the calculation unit into a reference information and constructing a third pattern from the reference information.

The present disclosure further provides a display method for a controller of a machine tool. The display method may include: by a fitting unit, converting a position information into a fitting parameter, constructing a first pattern from the position information, and constructing a second pattern from the fitting parameter; by a calculation unit, calculating an offset information between the first pattern and the second pattern; and by an integration unit, integrating the fitting parameter and the offset information into a reference information and constructing a third pattern from the reference information.

It can be appreciated from the above that in the display system and display method according to the present disclosure, with the design of the fitting unit, the calculation unit, and the integration unit, only a small amount of information (i.e., the fitting parameter and the offset information) is needed for reproducing the third pattern (or the machining path). Thus, compared to the multi-point path patterns reproduced by the prior art, the present disclosure is capable of reducing the computational resources and the memory usage required.

Moreover, a user only needs to input a tolerance for a third pattern (or a machining path) of a desirable configuration to be displayed after being processed by the calculation unit and the integration unit. Therefore, compared to a jittering multi-point path pattern reproduced by the prior art, the third pattern displayed by the display system according to the present disclosure allows the user to more easily ascertain the machining status of the machine tool based on the offsets from the original points shown thereon.

### BRIEF DESCRIPTION OF THE DRAWINGS

FIG. 1 is a block diagram depicting an application of a display system in accordance with the present disclosure;

FIG. 2 is a schematic diagram illustrating the operating framework and data processing of the display system in accordance with the present disclosure;

FIGS. 3A-1 to 3A-4 are schematic diagrams illustrating data processing operations of the display system in accordance with a first embodiment of the present disclosure;

FIGS. 3B-1 and 3B-2 are tables associated with FIGS. 3A-1 to 3A-4;

FIGS. 4A-1 to 4A-3, 4B-1 to 4B-4 and 4C-1 to 4C-3 are schematic diagrams illustrating data processing operations of the display system in accordance with a second embodiment of the present disclosure, wherein FIGS. 4B-1 and 4B-2 are tables associated with FIGS. 4A-1 and 4A-2; FIG. 4B-3 is a table associated with FIG. 4B-4; and FIG. 4C-2 is a table associated with FIG. 4C-1;

FIGS. 4D-1 and 4D-2 are other embodiments of FIGS. 4C-2 and 4C-3;

FIGS. 4E-1 and 4E-2 are other embodiments of FIGS. 4C-2 and 4C-3;

FIGS. 4F-1 and 4F-2 are other embodiments of FIGS. 4C-2 and 4C-3;

FIGS. 4G-1 and 4G-2 are other embodiments of FIGS. 4C-2 and 4C-3;

FIGS. 5A-1 to 5A-4, 5B-1 to 5B-4 and 5C-1 to 5C-3 are schematic diagrams illustrating data processing operations of the display system in accordance with a third embodiment of the present disclosure, wherein FIGS. 5B-1 and 5B-2 are tables associated with FIGS. 5A-1 and 5A-2; FIG. 5B-3 is a table associated with FIG. 5B-4; and FIG. 5C-2 is a table associated with FIG. 5C-1;

FIGS. 5D-1 and 5D-2 are other embodiments of FIGS. 5C-2 and 5C-3;

FIGS. 5E-1 and 5E-2 are other embodiments of FIGS. 5C-2 and 5C-3;

FIGS. 5F-1 and 5F-2 are other embodiments of FIGS. 5C-2 and 5C-3; and

FIGS. 5G-1 and 5G-2 are other embodiments of FIGS. 5C-2 and 5C-3.

### DETAILED DESCRIPTION OF THE EMBODIMENTS

The technical content of present disclosure is described by the following specific embodiments. One of ordinary skill in the art can readily understand the advantages and effects of the present disclosure upon reading the disclosure of this specification. The present disclosure may also be practiced or applied with other different implementations. Based on different contexts and applications, the various details in this specification can be modified and changed without departing from the spirit of the present disclosure.

It should be noted that the structures, ratios, sizes shown in the drawings appended to this specification are to be construed in conjunction with the disclosure of this specification in order to facilitate understanding of those skilled in the art. They are not meant, in any ways, to limit the implementations of the present disclosure, and therefore have no substantial technical meaning. Without affecting the effects created and objectives achieved by the present disclosure, any modifications, changes or adjustments to the structures, ratio relationships or sizes, are to be construed as fall within the range covered by the technical contents disclosed herein. Meanwhile, terms, such as “first”, “second”, “one”, “a”, “an”, and the like, are for illustrative purposes only, and are not meant to limit the range implementable by the present disclosure. Any changes or adjustments made to their relative relationships, without modifying the substantial technical contents, are also to be construed as within the range implementable by the present disclosure.

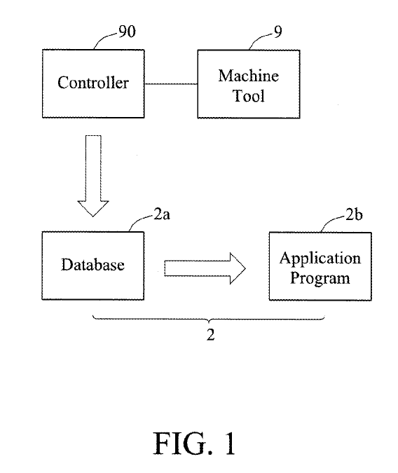

Referring to FIG. 1, a block diagram depicting an application of a display system 2 in accordance with the present disclosure is shown.

As shown in FIG. 1, the display system 2 is applied to a Computer Numerical Control (CNC) machine tool 9. The display system 2 can be, for example, a standard equipment of the machine tool 9 or a standalone computer (e.g., a remote computer, a personal computer, a tablet, a mobile phone, etc.) having the capabilities of calculating data and displaying calculated results.

In an embodiment, the operation of the display system 2 is during or after the machining process of the machine tool 9, and involves retrieving relevant data from the machine tool 9 and storing them into its database 2a, and then transmitting the data of the database 2a to its application program 2b (e.g., a calculation program or a drawing software).

Moreover, the retrieval of data by the display system 2 may be carried out via internal direct transmission (e.g., in a configuration where a digital controller of the machine tool 9 includes the database 2a), an application program interface (e.g., for obtaining internal data in the digital controller of the machine tool 9), a programmable logic controller (PLC) (for communicating with and temporarily storing signals of the digital controller), direct transmission from external device (e.g., an encoder transmitting position signals, an optical ruler transmitting position signals, a data acquisition card for transmitting positions, line numbers of NC program and G-codes).

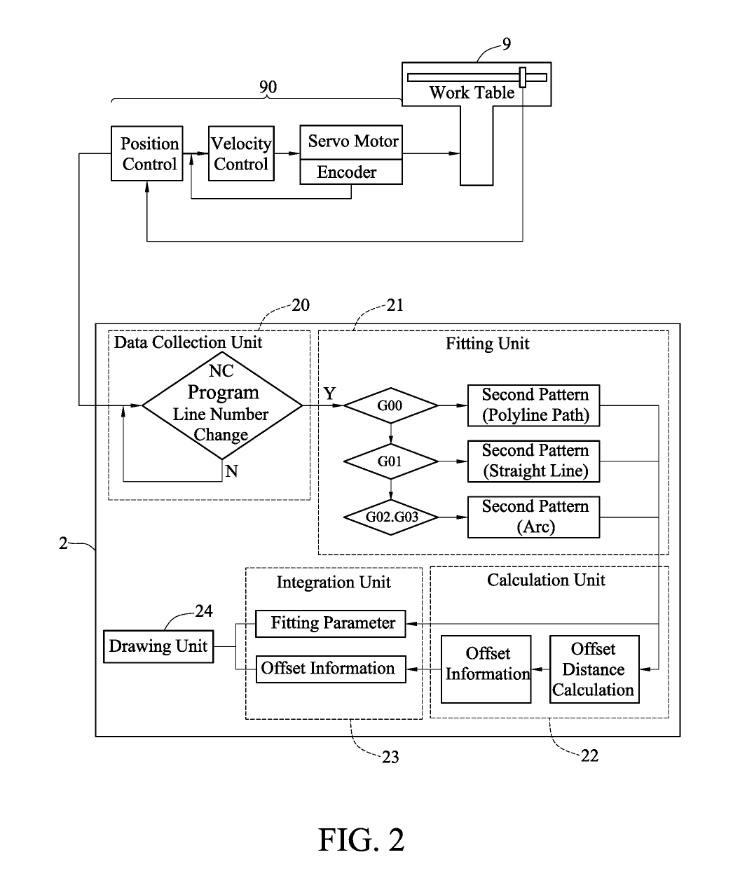

FIG. 2 is a schematic diagram illustrating the operating framework and data processing of the display system 2 in accordance with the present disclosure. As shown in FIG. 2, the operating framework of the display system 2 includes a data collection unit 20 (e.g., the database 2a), a fitting unit 21, a calculation unit 22, an integration unit 23, and a drawing unit 24, wherein the fitting unit 21, the calculation unit 22, the integration unit 23, and the drawing unit 24 can be programmed as one control unit by the application program 2b.

The data collection unit 20 is used for retrieving position information during or after a machining process and transmitting it to the fitting unit 21.

In an embodiment, the position information include, for example, position data of a machining path of the machine tool 9 during the machining process in conjunction with a G-Code command or a line number of a NC program. For example, the position information may include data such as position coordinates, G-codes, line numbers of NC program or other relevant instructions. In an embodiment, if a current line number and a previous line number of the NC program included in a real-time path information passed into the data collection unit 20 are the same, implying that the current operation has not finished yet, then the path information will be accumulated in a temporary memory. On the contrary, if the line number of the NC program changes (i.e., the NC program go to the next line), implying the machine tool 9 is entering the next operation, then the data collection unit 20 will trigger a path-fitting mechanism by which the accumulated and temporarily stored path information are transmitted to the fitting unit 21 for processing.

When the machine tool 9 is in operation, the display system 2 will obtain and store the position data of the machining path of the machine tool 9 from a plurality of sources, for example, using position control of a controller 90 of the machine tool 9, an encoder on a servo motor of the machine tool 9, an optical ruler on a work table, etc.; details of each are described below.

The position control of the controller 90 is internally maintained position coordinates. During a normal execution process of machining NC program, the core of the controller 90 will preload a certain number of machining programming codes in units of “line.” Then, the instructions represented by the NC program in a line are sequentially interpreted and stored in a command cache of the controller 90. On the other hand, the commands are taken out from the front end of the command cache and interpreted to get target position coordinate values, which are used as the internally maintained position coordinate values of the controller 90. They may include mechanical coordinates, working coordinates, etc. displayed on a human machine interface of the controller 90.

The encoder on the servo motor or an optical ruler on the work table is a device external to the machine tool 9. The actual positions are first obtained and fed back to the controller 90 for compensation. The encoder is often incorporated at the rear end of the servo motor for calculating the actual position of the table of the machine tool 9 based on the number of revolutions and angles. The optical ruler is usually fastened to a mechanical part that generates axis travel for accurately obtaining its position.

The fitting unit 21 is used for simplifying the position information to a fitting parameter, wherein the position information is converted into a first pattern, and the fitting parameter constructs a second pattern. More specifically, based on the specific programming code (e.g., G-Code command) in the received position information, the position information is categorized in order to be converted into a fitting parameter, and the second pattern corresponding to the fitting parameter is fitted to the first pattern represented by the position information in order to quickly reproduce a pattern representing data points of the path information.

In an embodiment, G-codes that are associated with movements include G00, G01, G02, and G03, wherein G00 entails that the machining path is a polyline (a fitted pattern or second pattern); G01 entails that the machining path is a straight line (fitted pattern or the second pattern); and G02 and G03 entail that the machining path is a clockwise- and counterclockwise circular arc (fitted pattern or the second pattern), respectively.

G00 is used for planning a straight-line or a polyline motion for a machining path of the machine tool 9, but it does not involve machining (or so-called “dry run”). Thus, the machining path drawn based on the position information of the original path will have a straight-line or polyline path. As a result, for this type of machining path, the fitting unit 21 will perform fitting using a polyline approach.

G01 is used for planning a straight-line motion for a machining path of the machine tool 9. Machining on the workpiece is performed during this movement. A counterforce produced when machining a workpiece may cause the tool to deviate from its originally planned machining path, so correction can be made to return the tool to its original machining path through, for example, position compensation. Since G01 is used for planning a straight-line motion for the tool, the machining path drawn based on the position information of the original path will generally be a straight line, so for this type of machining path, the fitting unit 21 will perform fitting using a straight-line approach.

G02 and G03 are used for planning arc motions for a machining path of the machine tool 9. Machining on the workpiece is performed during this movement. A counterforce produced when machining a workpiece may cause the tool to deviate from its originally planned machining path, so correction can be made to return the tool to its original machining path through, for example, position compensation. Since G02 and G03 are used for planning arc motions for the tool, the machining path drawn based on the position information of the original path will generally be an arc, so for this type of machining path, the fitting unit 21 will perform fitting using an arc approach.

The calculation unit 22 is used for calculating offset information between the first and second patterns. In other words, when a path segment produced by the fitting unit 21 deviates from that in the originally planned machining path, the calculation unit 22 obtains information related to the offset distances of the path segment.

In an embodiment, the offset information includes data, which are offset distances between path points of the first and second patterns greater than a predetermined tolerance. More specifically, when an offset distance is less than the tolerance, it is ignored, whereas when an offset distance is greater than the tolerance, it is recorded. Therefore, the calculation unit 22 deals with the situation in which the tool deviates from the originally-planned machining path due to external factors, such as counterforce produced while machining a material, abnormal machining, etc. In particular, the offset distance of a path point that is less than the tolerance is ignored, while the data of the offset distance greater than the tolerance is recorded, thereby obtaining offset information (or pattern deviation information).

Furthermore, since G00 does not involve machining on the workpiece, there is no warrant for user review, and is therefore not displayed on the human machine interface or a computer screen. As a result, the calculation unit 22 does not keep information about the deviated segments during movement of the tool controlled by G00.

Moreover, the second pattern reflecting G01 is a straight line, while the second pattern reflecting G02 or G03 is an arc. Since machining is performed for all of these three codes, the calculation unit 22 will keep those offset segments that are too large to be omitted (the offset distance larger than the tolerance) during the movements of the tool controlled by G01, G02 or G03.

The integration unit 23 integrates the fitting parameter of the fitting unit 21 and the offset information (or pattern deviation information) of the calculation unit 22 into a group of complete reference information, which will form a third pattern.

The drawing unit 24 is used for automatically drawing the third pattern (especially the offset segments of a path) based on the reference information provided by the integration unit 23, including in particular, the offset information (associated path points) from the calculation unit 22.

In an embodiment, the third pattern (the offset segments of a path) is constructed by the drawing unit 24 from path points of the offset information (or pattern deviation information) by continuously joining one path point with the next to form line segments, and the third pattern is then displayed on the human machine interface (or the computer screen).

FIGS. 3A-1 to 3A-4 are schematic diagrams illustrating data processing operations of the display system 2 in accordance with a first embodiment of the present disclosure. In an embodiment, operations subsequent to the data collection unit 20 transmitting position information of a machining path to the fitting unit 21 are described.

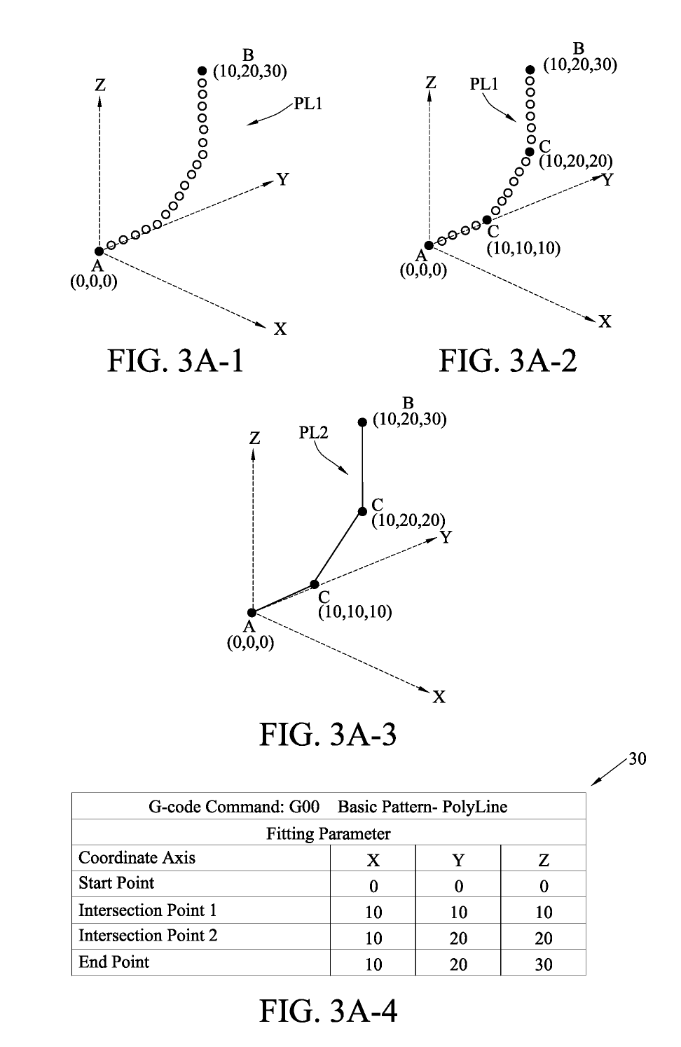

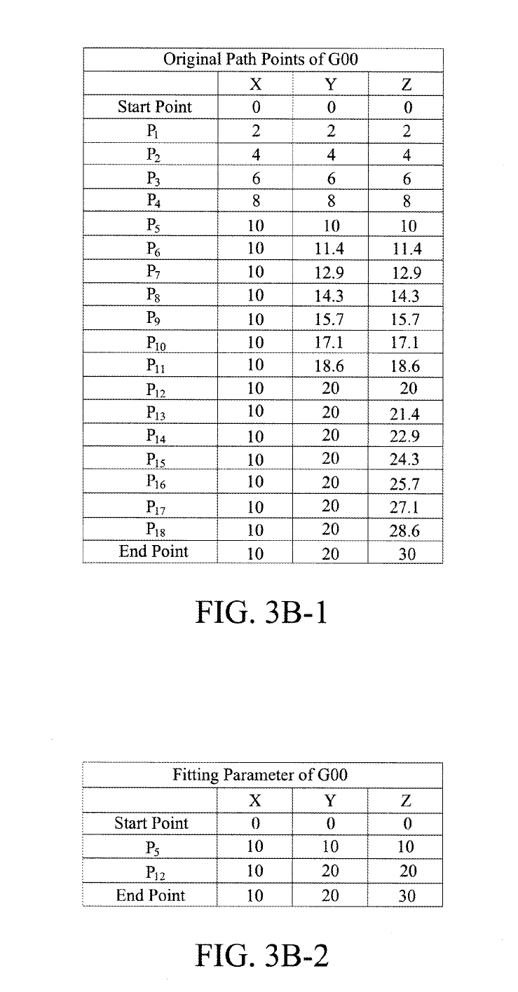

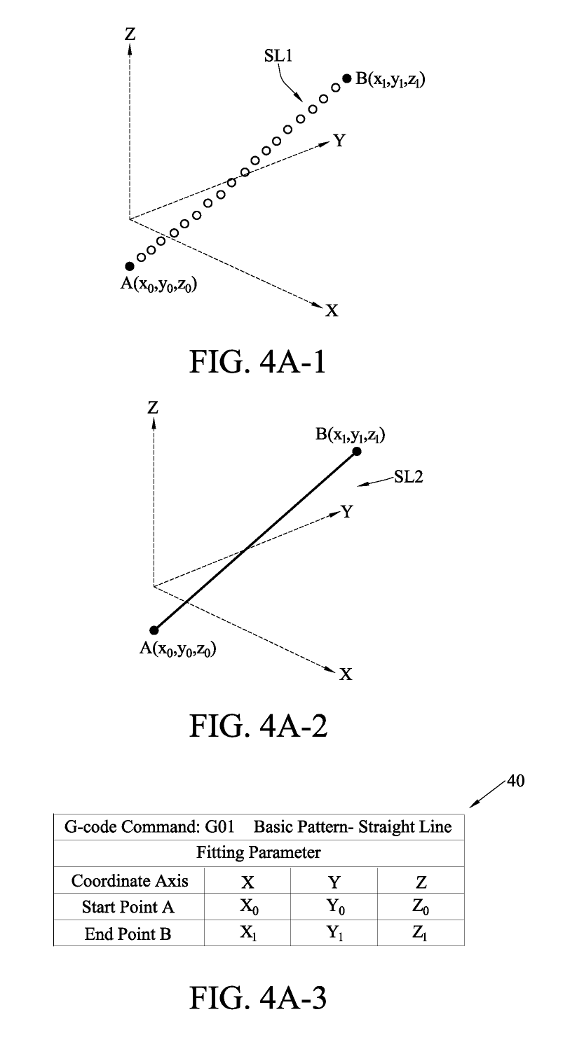

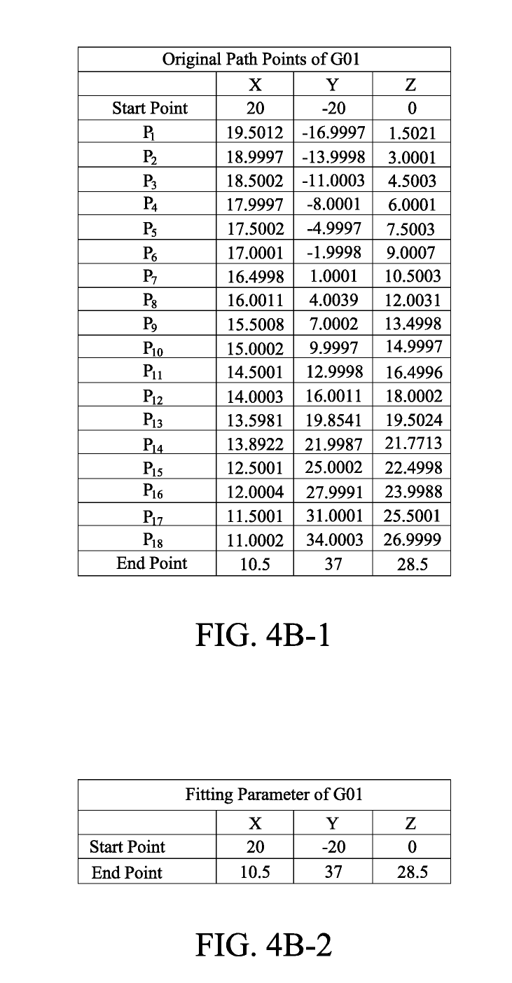

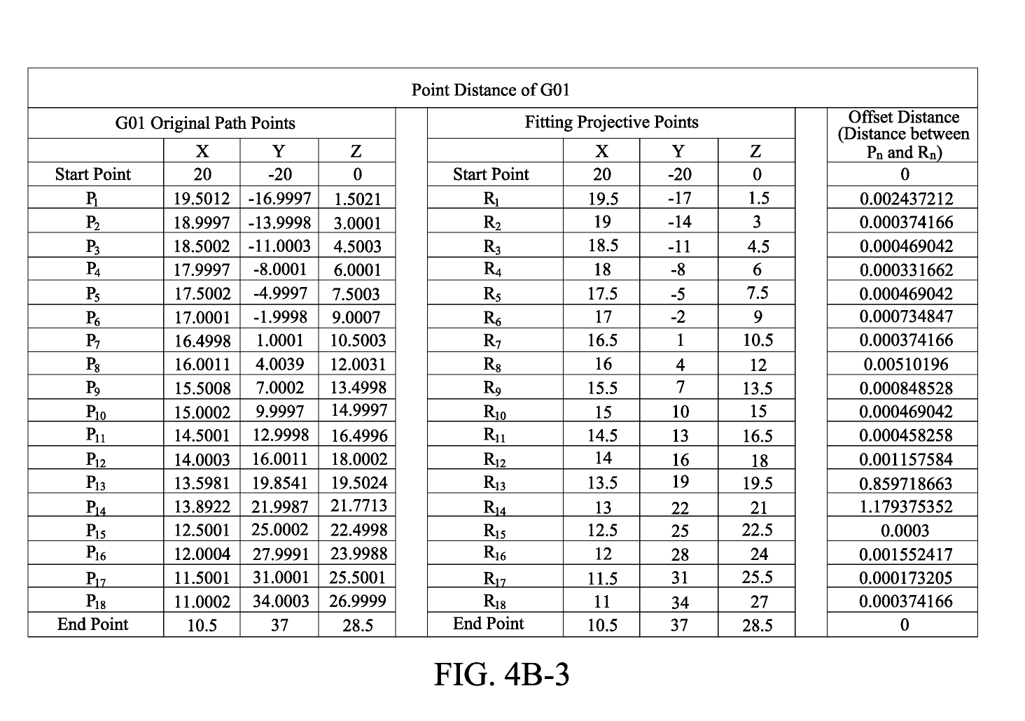

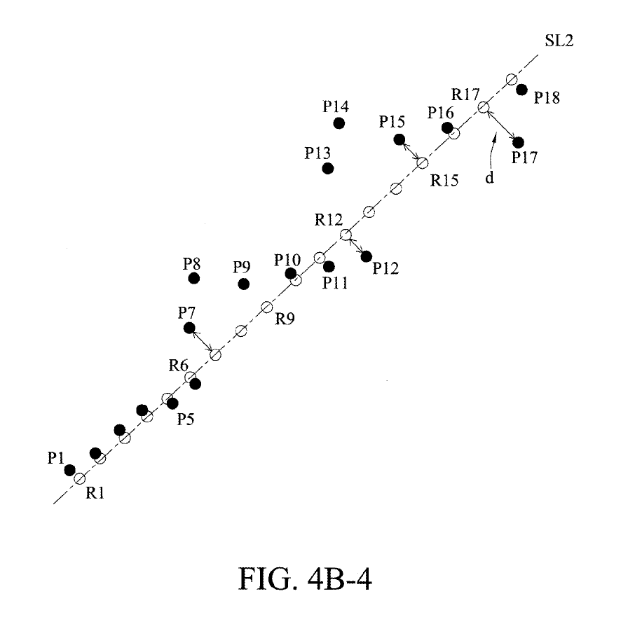

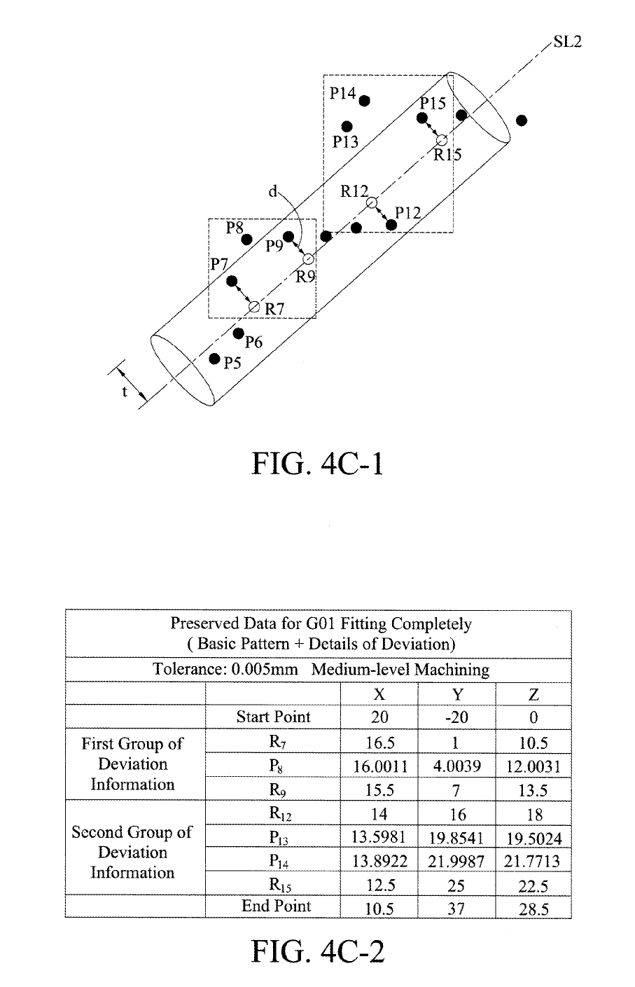

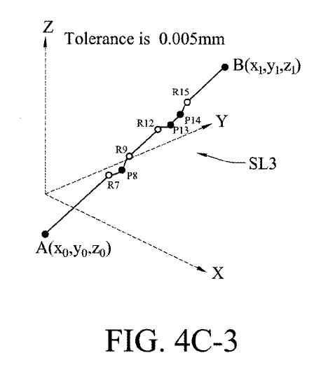

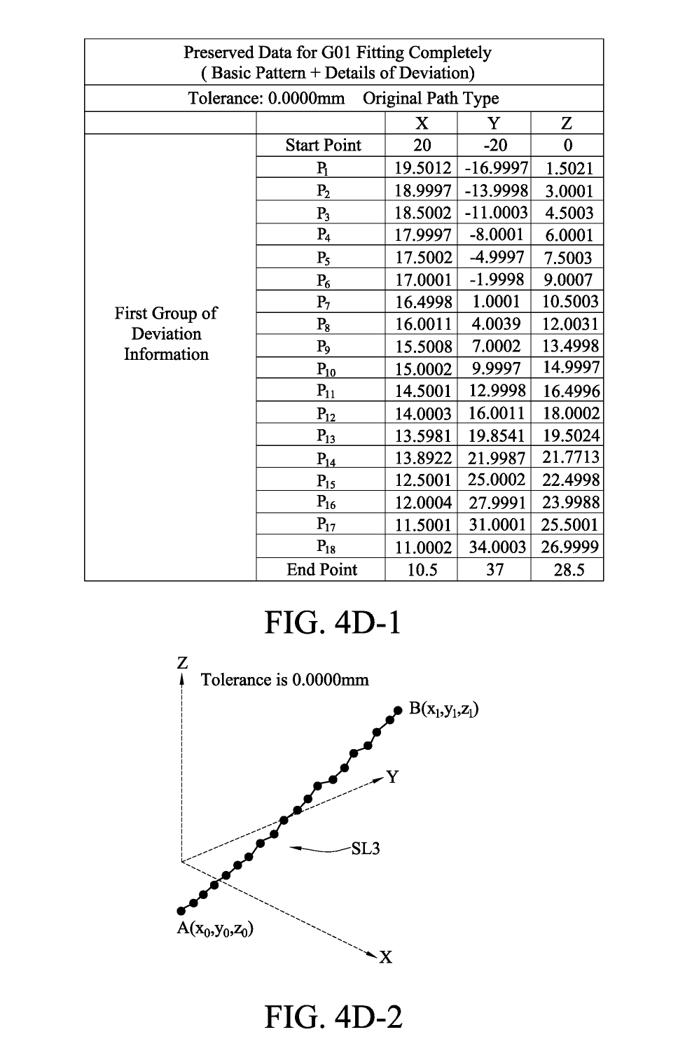

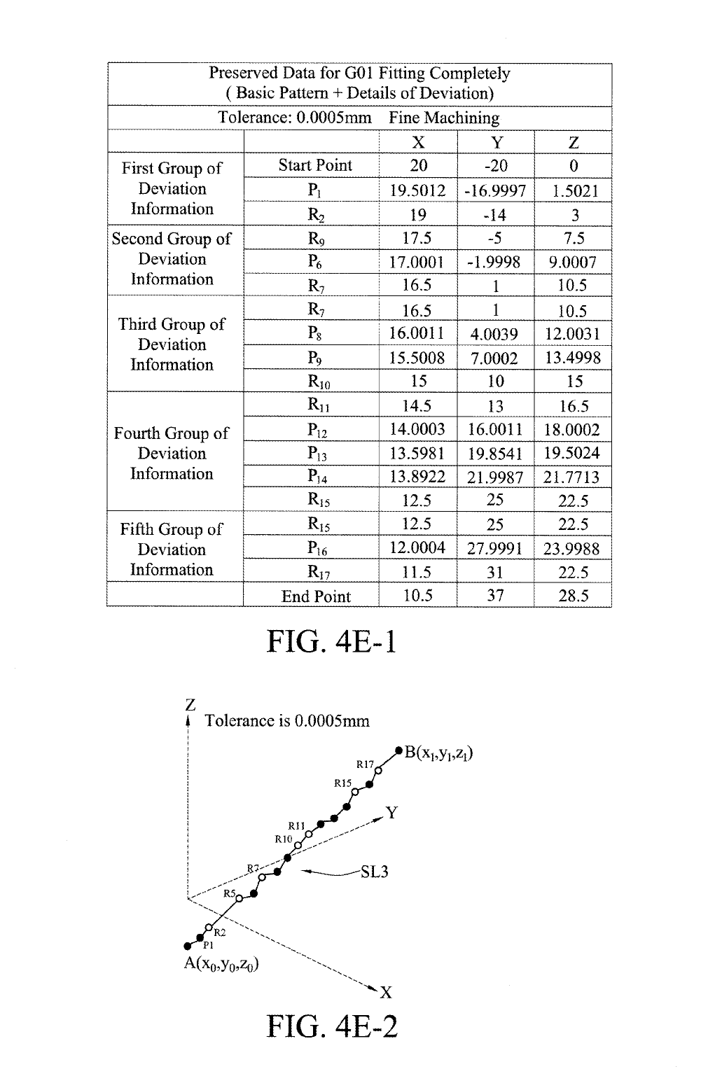

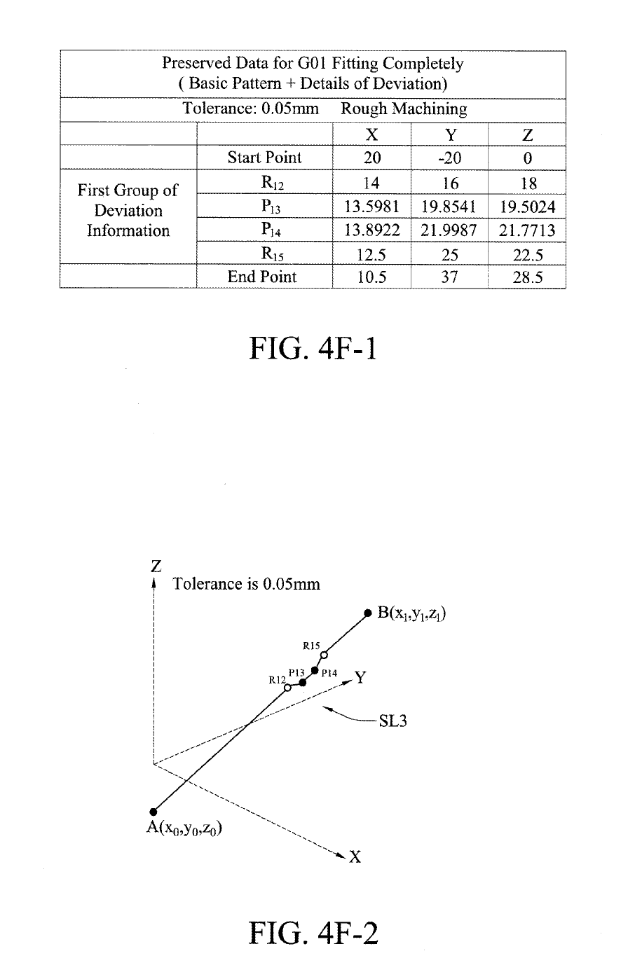

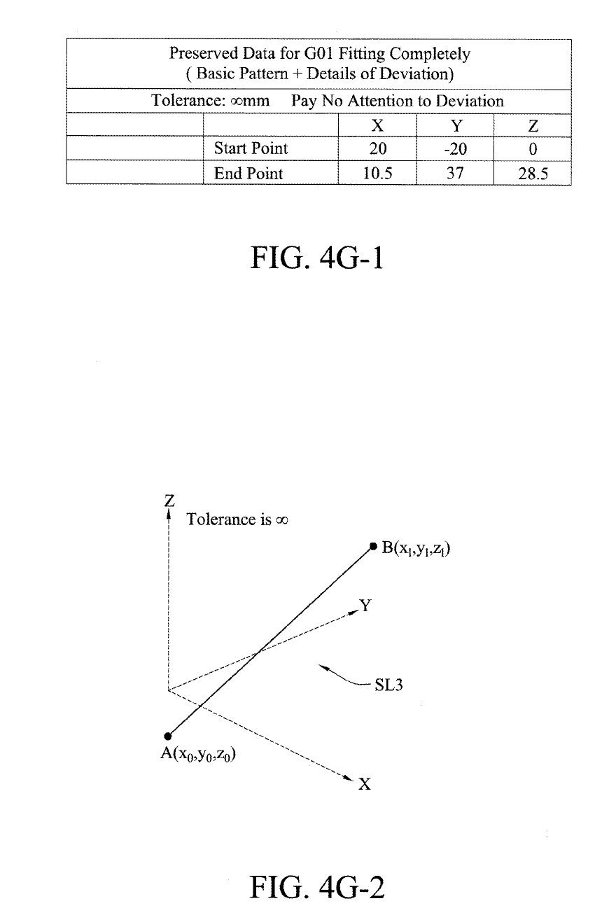

As shown in FIG. 3A-4, the fitting unit 21 converts the position information of the machining path transmitted by the data collection unit 20 into a fitting parameter of the machining path.

In an embodiment, the position information include path points on a polyline path for G00, and the fitting unit 21 converts it into a fitting parameter in fitted data 30 on a human machine interface as shown in FIG. 3A-4. In the position information, a start point A (as shown in FIG. 3A-1) is the first path point of a first pattern PL1 representing the position information; an end point B (as shown in FIG. 3A-1) is the last path point of the first pattern PL1 representing the position information; and intersection points (as shown in FIG. 3A-2) are intersection points C at which the first pattern PL1 representing the position information makes a turn. There will be no record of an intersection point if there is none. Therefore, after fitting, the fitting unit 21 will create a second pattern PL2 (a fitted pattern or a basic pattern) such as the one shown in FIG. 3A-3 and the fitted data 30 shown in FIG. 3A-4.

A straight-line simplifying method (for creating a function) is used for the conversion of the G00, and includes the following steps.

(1) First, the following straight line equation passing through two points (x₀,y₀,z₀) and (x₁,y₁,z₁) in space is used:

[(x−x₀)/(x₁−x₀)]=[(y−y₀)/(y₁−x₀)]=[(z−z₀)/(z₁−z₀)].

(2) Then, intersection point(s) is found. Since polyline is a connected series of straight line segments. Due to the non-synchronous motion characteristic of the servo motors of different axes, the tool will first move to a target point on one of the axes, then to a target point on a second one of the axes, and so on. Therefore, in view of this characteristic, one way of searching for an intersection point is to sequentially check position coordinate values of each axis in the series of path points for changes, and when the position coordinate values of all of the axes change from their previous values, implying that each axis is moving in space, then the previous points are ignored; when the position value of an axis is the same as its previous value, then the previous points are preserved. More specifically, as shown in FIG. 3B-1, a search begins from the start point. At point P6, the X-axis coordinate is found to be the same as that in point P5, meaning that point P5 is an intersection point, so point P5 is stored. Then, at point P13, the Y-axis coordinate is found to be the same as that in point P12, meaning that point P12 is also an intersection point, so point P12 is stored.
(3) Finally, the start point A, the intersection points C (points P5 and P12), and the end point B are preserved as the simplified parameter shown in FIG. 3B-2. A fitted pattern for G00 can then be drawn, such as the second pattern PL2 shown in FIG. 3A-3.

Since no machining is involved for G00, the calculation unit 22 will not keep any offset segment during the movement of the tool, that is, subsequent processing is not required.

FIGS. 4A-1 to 4C-3 are schematic diagrams illustrating data processing operations of the display system 2 in accordance with a second embodiment of the present disclosure. In an embodiment, operations subsequent to the data collection unit 20 transmitting position information of a machining path to the fitting unit 21 are described.

First, as shown in FIGS. 4A-1 to 4B-2, the position information of the machining path include position information of a straight line for G01 as shown in FIG. 4B-1, and the position information is constructed into a first pattern SL1 (as shown FIG. 4A-1). The fitting unit 21 converts the position information into a fitting parameter of the machining path shown by fitted data 40 of the human machine interface of FIG. 4A-3.

In an embodiment, in the position information, a start point A (as shown in FIG. 4A-1) is the first path point of the first pattern SL1 representing the position information; and an end point B (as shown in FIG. 4A-1) is the last path point of the first pattern SL1 representing the position information. Therefore, after fitting, the fitting unit 21 will create a second pattern SL2 (a fitted pattern or a basic pattern) such as the one shown in FIG. 4A-2 and the fitted data 40 in FIG. 4A-3. More specifically, the conversion of G01 involves substituting the start point A and the end point B into the straight-line equation passing through two points in order to obtain a segment function joining the start and the end points. A search begins at the start point. At the end of the search, only the start point A and the end point B remain (since the two points form a straight line), as shown in FIG. 4B-2, and a path-fitted pattern for G01 can then be drawn, such as the second pattern SL2 shown in FIG. 4A-2.

Since machining is involved in the instruction of G01, the calculation unit 22 will keep offset segments that are too large to be ignored during the movements of the tool.

As shown in FIGS. 4B-3 and 4B-4, the calculation unit 22 calculates offset distances d between all original points P (the original path points shown in FIG. 4B-1) in the first pattern SL1 of the position information and the second pattern SL2 (such as the fitted straight line). More specifically, when calculating an offset distance d, the distance between an original point P (shown as a solid dot in FIG. 4B-4) and a projected point R (shown as a hollow dot in FIG. 4B-4) on the second pattern (i.e., the fitted straight line) can be used as the offset distance. The calculation unit 22 captures data, i.e., points (e.g., original points P8, P13, P14 in FIG. 4C-1) whose offset distances d are greater than a predetermined tolerance t (e.g., the tolerance is 0.005 mm in FIGS. 4C-1 and 4C-2, i.e., medium-level machining) The calculation unit 22 records these points P8, P13, P14 as shown in FIG. 4C-2.

At this time, the calculation unit 22 further obtains projected points R7, R9, R12, R15 corresponding to original points P7, P9, P12, P15 adjacent to the original points P8, P13, P14. In order to have continuity between the line segments, each offset data greater than the tolerance t is recorded along with two projected points corresponding to the original points immediately adjacent to the offset data. Thus, each group of deviation information includes a start fitting projective point (e.g., projected point R7/R12), at least one offset point (e.g., original point P8/P13/P14), and an end fitting projective point (e.g., projected point R9/R15). As shown in FIGS. 4C-1 and 4C-2, a first group of deviation information includes R7, P8, R9; and a second group of deviation information includes R12, P13, P14, R15. Therefore, the offset information are organized into required deviation information (or pattern deviation information), as shown in FIG. 4C-2, before being passed onto the integration unit 23.

Thereafter, as shown in FIG. 4C-3, after receiving the fitting parameter of the fitting unit 21 and the offset information from the calculation unit 22, the integration unit 23 integrates the two into reference information that will form a third pattern SL3.

In an embodiment, all offset points are recorded chronologically to be consolidated into the reference information, and the third pattern SL3 (machining path) includes the start point, one or more sets of offset points, and the end point.

Finally, once the integration unit 23 completes the integration of the fitting parameter and the offset information into the reference information, the reference information is sent to the drawing unit 24 for drawing.

It can be understood from the above that by exploiting the characteristics of NC instructions and the actual path points, i.e., determining the associations between line numbers/G-codes/path points, fitting is performed to calculate a segment equation and values, such that large quantity of short segment information (e.g., the first pattern SL1) is converted into small quantity of long segments (e.g., the second pattern SL2) to replace the position information of the original points, and machining path information is further stored. Thus, when redrawing a machining path, less memory usage and system computational resources are needed.

In the actual machining process, users will need to pay more attention to places with large machining offset errors. The third pattern SL3 formed using the offset calculation method above is able to highlight this aspect of the machining process.

Therefore, after the user specifies the tolerance, the display system 2 reproduces the machining path and automatically displays it on the human machine interface 1, such as the third pattern SL3 (machining path pattern) shown in FIG. 4C-3. By examining the third pattern SL3, the user is able to get an idea on the machining status of the workpiece (for example, when a non-straight-line machining path is shown, the original points P8, P13, P14 can be seen as offset), and to determine where the machine tool 9 has failed to work or done a poor job. During the production of the next batch, parameters of the machine tool 9 can be adjusted to address places that had poor machining results.

It can be appreciated that the calculation unit 22 is able to adjust the tolerance t as needed (the tolerance is shown as 0, 0.0005 mm, 0.05 mm and infinity in FIGS. 4D-1, 4E-1, 4F-1, and 4G-1, respectively, corresponding to “original”, “fine machining”, “rough machining”, “pay no attention to deviation”, respectively), such that different original points P are included within or outside the tolerance, resulting in different offset information (as shown in FIGS. 4D-1, 4E-1, 4F-1, and 4G-1) and different reference information (or third patterns) being transmitted to the drawing unit 24, where different third patterns SL3 are drawn, as shown in FIGS. 4D-2, 4E-2, 4F-2, and 4G-2.

FIGS. 5A-1 to 5C-3 are schematic diagrams illustrating data processing operations of the display system 2 in accordance with a third embodiment of the present disclosure. In an embodiment, operations subsequent to the data collection unit 20 transmitting position information of a machining path to the fitting unit 21 are described.

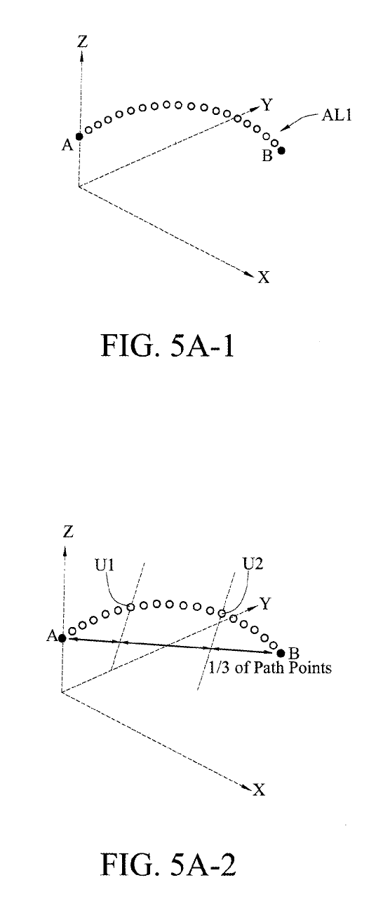

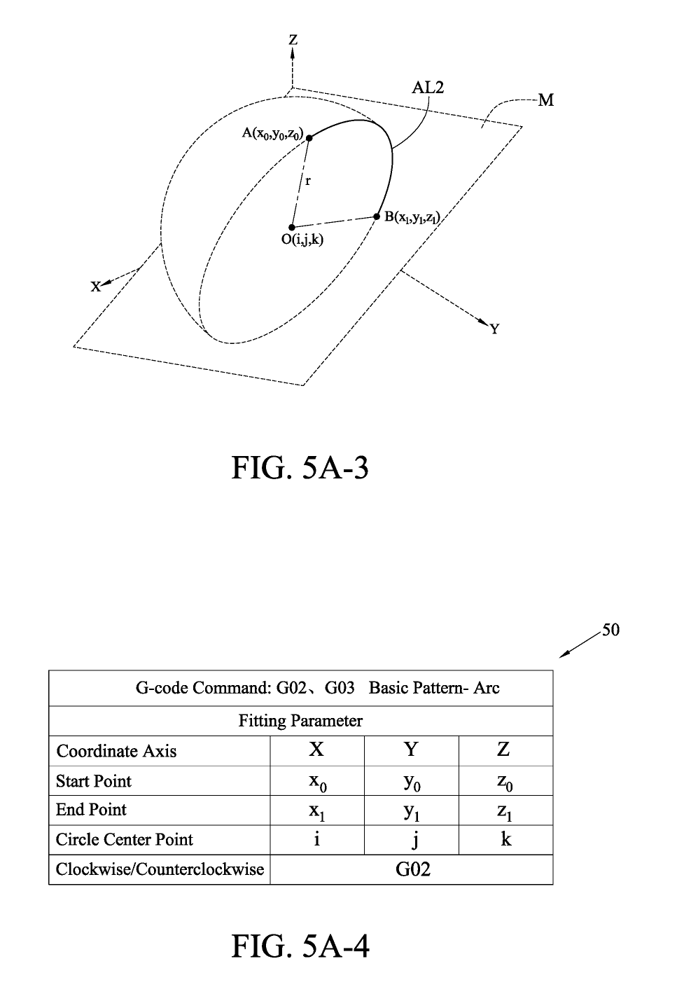

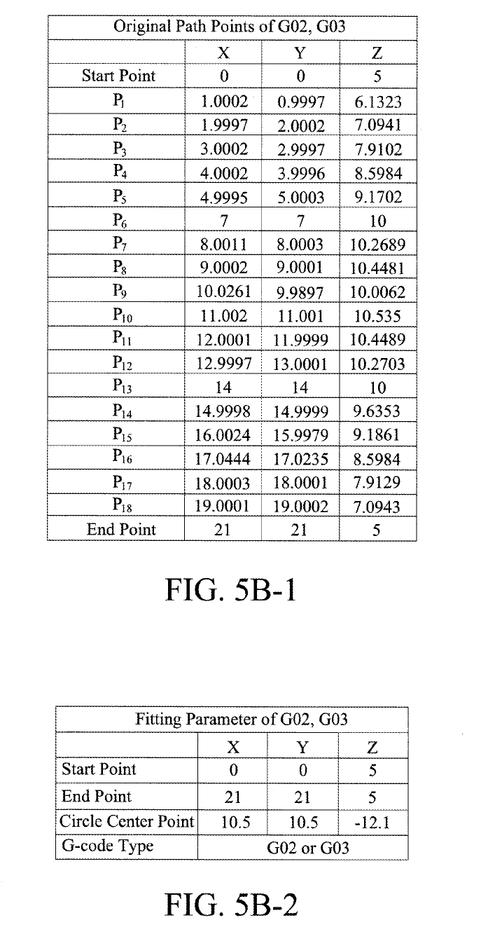

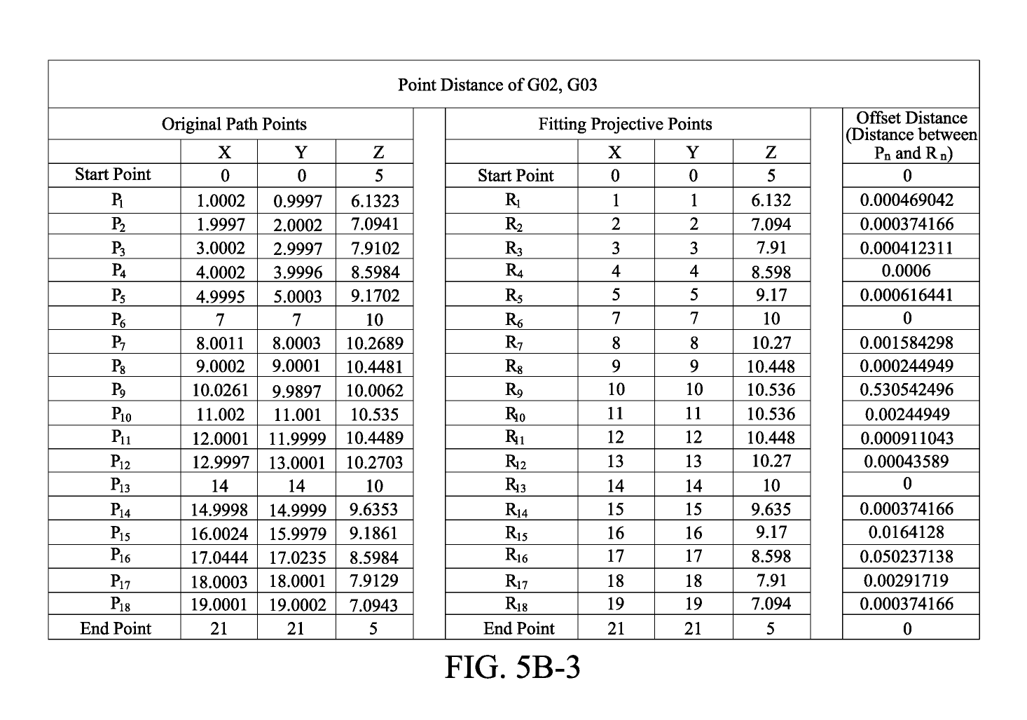

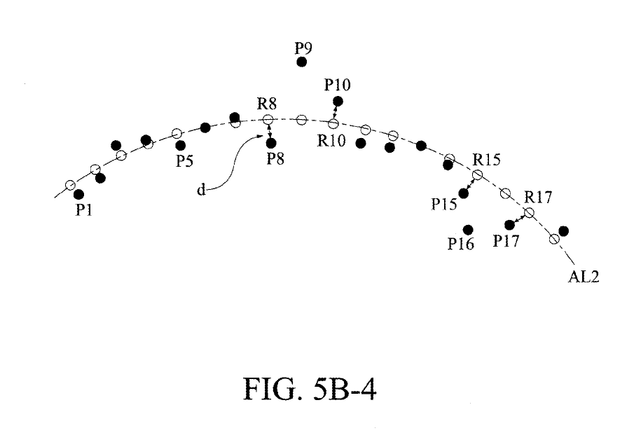

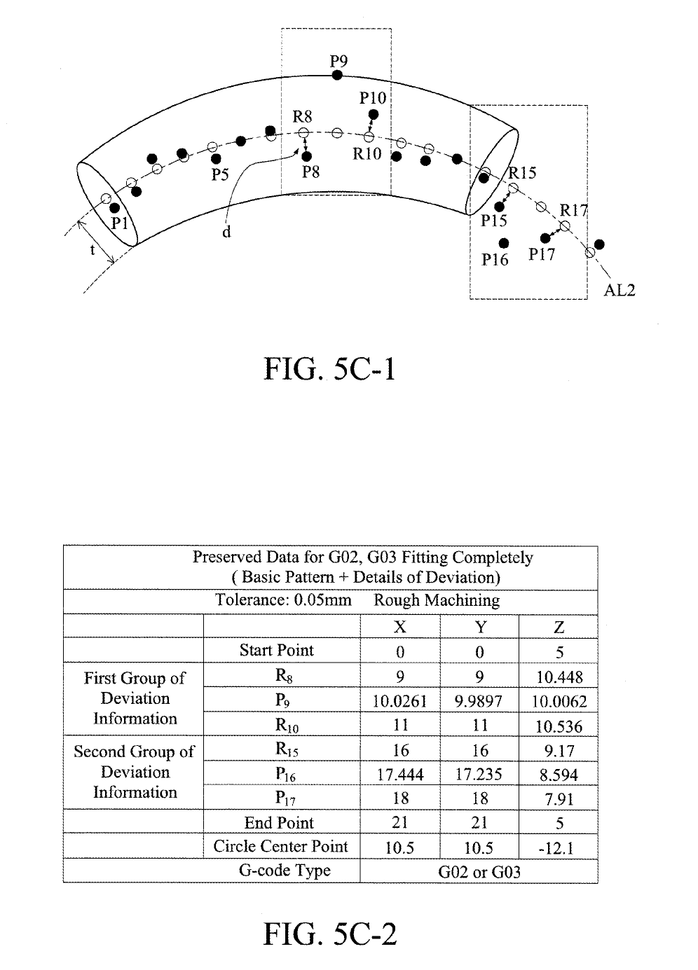

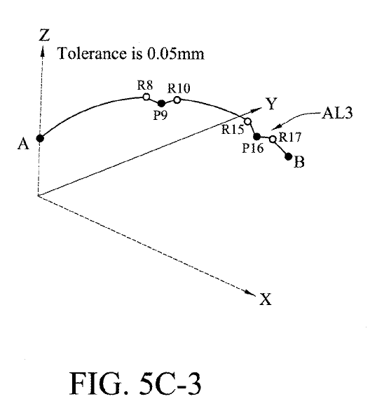

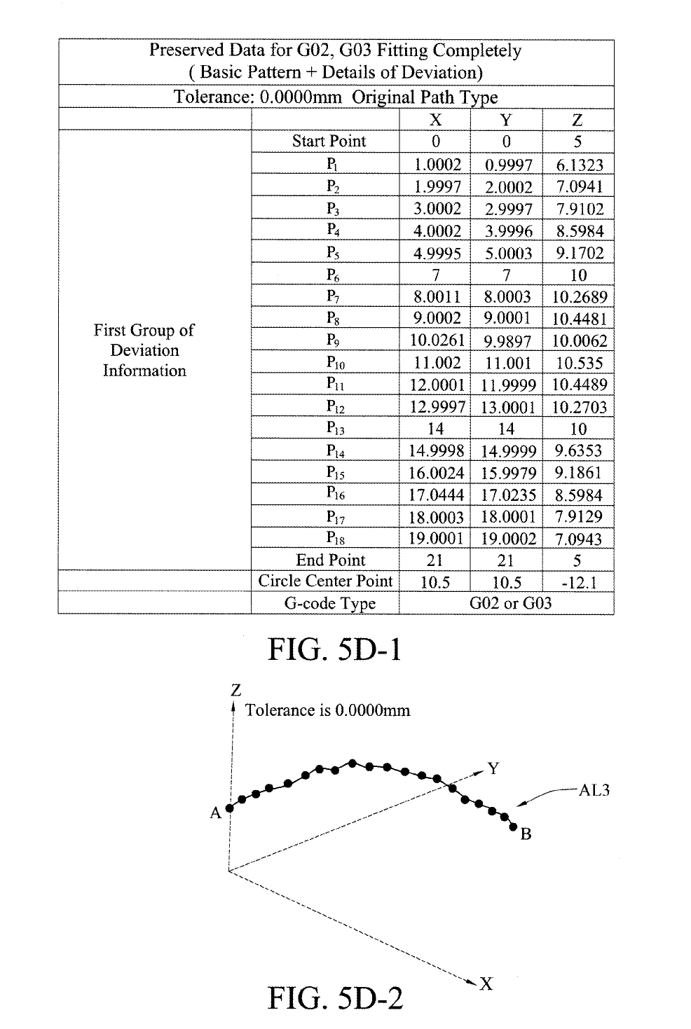

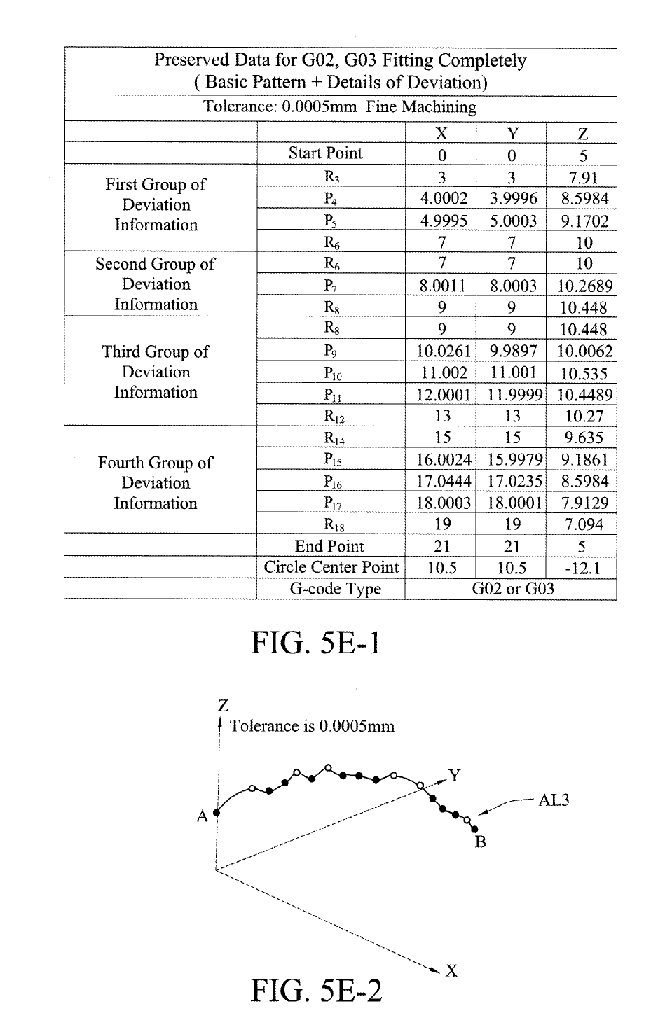

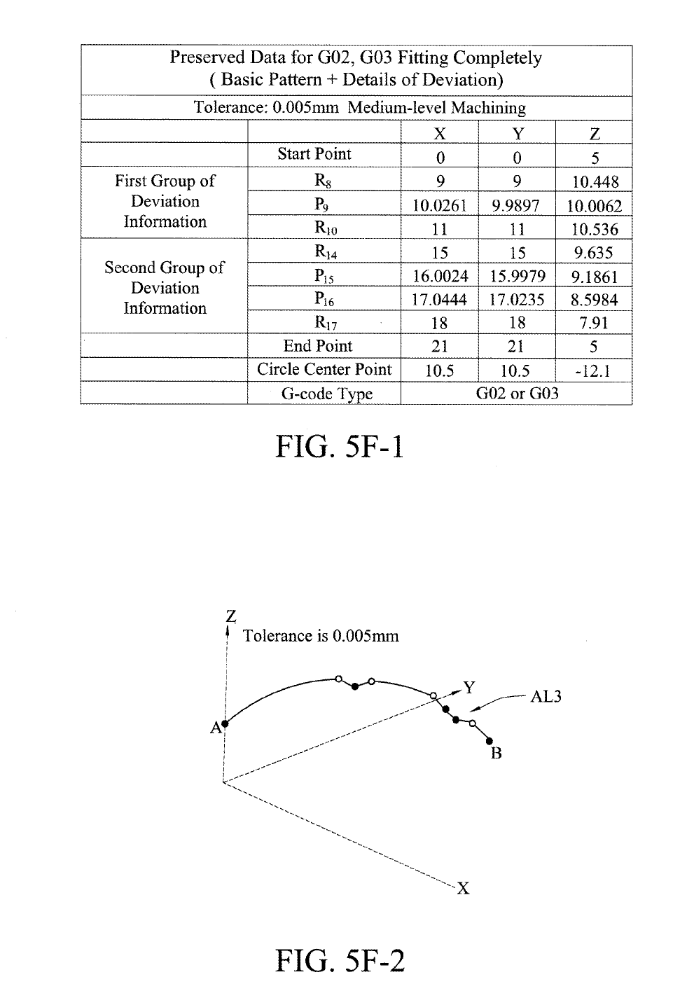

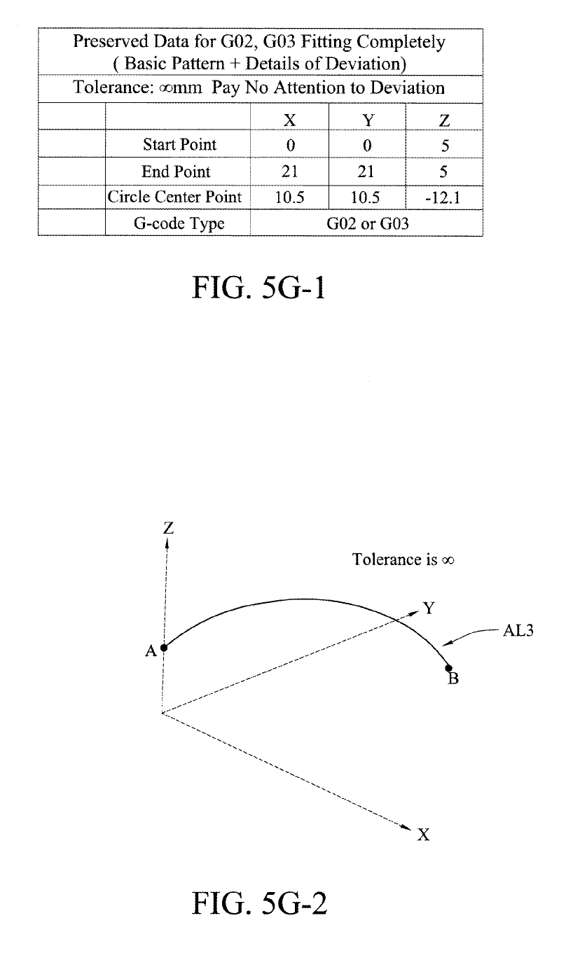

First, as shown in FIG. 5A-1 to 5A-3, the position information of the machining path include position information of an arc for G02 or G03, and the fitting unit 21 converts the position information into a fitting parameter shown in fitted data 50 of FIG. 5A-4, wherein the difference between G02 and G03 is in the rotating direction of the machining path, wherein G02 entails a clockwise direction, and G03 entails a counterclockwise direction.

In an embodiment, the position information uses G02 as an example (the difference between G02 and G03 is only that the start and end points are swapped). A start point A (as shown in FIG. 5A-1) is the first path point of a first pattern AL1 representing the position information. An end point B (as shown in FIG. 5A-1) is the last path point of the first pattern AL1 representing the position information. A circle center point (as shown by center O in FIG. 5A-3) is defined mathematically (a spherical equation and its center point can be obtained from four points on the sphere) using the start point A, the end point B, a point U1 at ⅓ of the path points of the path information (shown in FIG. 5A-2), and a point U2 at ⅔ of the path points of the path information (shown in FIG. 5A-2). Therefore, after fitting, the fitting unit 21 will create a second pattern AL2 (an arc-shaped fitted pattern) such as the one shown in FIG. 5A-3 and the fitted data 50 in FIG. 5A-4.

The circle center point O is calculated as follows.

(1) The spherical equation is (x−i)²+(y−j)²⁺(z−k)²=r², wherein the circle center point is (i,j,k) with a radius of r.
(2) To solve four unknown i, j, k, r, four points are required as inputs.
(3) From the position information, the start point A and the end point B can be obtained. Two other path points on the arc are needed.
(4) Assuming data fall on the arc line or in proximity to the arc line, points U1 and U2 at ⅓ and ⅔ of the path points on the arc are taken, as shown in FIG. 5A-2, thereby obtaining four points.
(5) Substitute these four points into the spherical equation to solve the four unknown i, j, k, r.
(6) An equation for a plane on which the arc exists is derived as follows:

[symbol]

=(x₀−i,y₀−j,z₀−k);

[symbol]

=(x₁−i,y₁−j,z₁−k);

Assuming the normal vector of M [symbol] =(a,b,c), then [symbol] ⊥ [symbol] and [symbol] ⊥ [symbol] , that is [symbol] · [symbol] =0 and [symbol] · [symbol] =0, therefore

[symbol]

={(y₁−j)(z₀−k)−(y₀−j)(z₁−k),(x₀−i)(z₁−k)−(x₁−i)(z₀−k),(x₁−i)(y₀−j)(−(x₀−i)(y₁−j)};

And the equation for plane M would be:

[(y₁−j)(z₀−k)−(y₀−j)(z₁−k)](x−i)+[(x₀−i)(z₁−k)−(x₁−i)(z₀−k)](y−j)+[(x₁−i)(y₀−j)(−(x₀−i)(y₁−j)](z−k)=0

(7) The equation for the plane M and the spherical equation (x−i)²+(y−j)²+(z−k)²=r² are intersected to obtain a calculated trajectory on the arc.

As shown in FIG. 5B-1, since any four points determine a spherical equation in space, so the start point, the end point, a point U1 at ⅓ of the data, and a point U2 at ⅔ of the data are used to obtain the sphere with a center O (10.5, 10.5, −12.1) and a radius of 22.648. Since the arc is bound to be on the plane M formed by the start point, the end point, and the center, so by intersecting the spherical equation and the equation for plane M obtained based on three points, a circle in space can be obtained. Based on the clockwise direction dictated by G02, it can be determined whether the path trajectory is the major or the minor arc as defined by the start point A and the end point B. Therefore, the record data for the data points of the arc can be simplified to just “start point, end point, center, radius, and G02 (or G03)”; further, since the radius can be obtained from the center and the start point, the radius can be omitted, left with just “start point, end point, center, and the type of G-code”, as shown in FIG. 5B-2. As such, a fitted pattern for G02 (or G03) can be drawn, as shown by the second pattern AL2 in FIG. 5A-3.

Therefore, to obtain an arc, the data can be simplified to “start point, end point, center, radius, and G02 (or G03)”, i.e., the fitting parameter in the fitted data 50.

Since machining is involved in the instruction of G02 or G03, the calculation unit 22 will keep offset segments that are too large to be ignored during the movements of the tool.

In an embodiment, the calculation unit 22 calculates offset distances d between all original points P in the position information and the second pattern AL2 (such as the fitted straight arc shown in FIG. 5B-4). More specifically, when calculating an offset distance d, the distance between an original point P (shown as a solid dot in FIG. 5B-4) and a projected point R (shown as a hollow dot in FIG. 5B-4) on the second pattern A12 (i.e., the fitted straight arc in FIG. 5B-4) can be used as the offset distance. The calculation unit 22 captures data, i.e., points (e.g., original points P9, P16 in FIG. 5C-1) whose offset distances d are greater than a predetermined tolerance t (e.g., the tolerance is 0.05 mm in FIGS. 5C-1 and 5C-2, i.e., rough machining) The calculation unit 22 records these points P9, P16 as shown in FIG. 5B-2.

At this time, the calculation unit 22 further obtains projected points R8, R10, R15, R17 corresponding to original points P9, P10, P15, P17 immediately adjacent to the original points P9, P16. In order to have continuity between the line segments, each offset data greater than the tolerance t is recorded along with two projected points corresponding to the original points immediately adjacent to the offset data. Thus, each group of deviation information includes a start fitting projective point (e.g., projected point R8/R15), at least one offset point (e.g., original point P9, P16), and an end fitting projective point (e.g., projected point R10/R17). More specifically, as shown in FIGS. 4C-1 and 4C-2, a first group of deviation information includes R7, P8, R9; and a second group of deviation information includes R12, P13, P14, R15. Therefore, the deviation information are organized into required offset information (or pattern deviation information), as shown in FIG. 5C-2, before being passed onto the integration unit 23.

Thereafter, as shown in FIG. 5C-3, after receiving the fitting parameter of the fitting unit 21 and the offset information from the calculation unit 22, the integration unit 23 integrates the two into a complete reference information that will form a third pattern AL3.

In an embodiment, all offset points are recorded chronologically to be consolidated into the reference information, and the third pattern AL3 includes the start point, one or more sets of offset points, the circle center point, the type of G-code, and the end point.

Finally, once the integration unit 23 completes the integration of the fitting parameter and the offset information into the reference information, the reference information is sent to the drawing unit 24 for drawing.

It can be understood from the above that after the user specifies the tolerance, the display system 2 reproduces the machining path and automatically displays it on the human machine interface 1, such as the third pattern AL3 (machining path pattern) shown in FIG. 5C-3. By examining the third pattern AL3, the user is able to get an idea on the machining status of the workpiece (for example, when a non-regular arc machining path is shown, the original points P9, P16 can be seen as offset), and to determine where the machine tool 9 has failed to work or done a poor job. During the production of the next batch, parameters of the machine tool 9 can be adjusted to address places that had poor machining results.

It can be appreciated that the calculation unit 22 is able to adjust the tolerance t as needed (the tolerance is shown as 0, 0.0005 mm, 0.05 mm and infinity in FIGS. 5D-1, 5E-1, 5F-1, and 5G-1, respectively, corresponding to “original”, “fine machining”, “rough machining”, “pay no attention to deviation”, respectively), such that different original points P are included within or outside the tolerance, resulting in different offset information (as shown in FIGS. 5D-1, 5E-1, 5F-1, and 5G-1) and different reference information (or third patterns) being transmitted to the drawing unit 24, where different third patterns AL3 are drawn, as shown in FIGS. 5D-2, 5E-2, 5F-2, and 5G-2.

Furthermore, the above embodiments show patterns for a 3D coordinate system, but other embodiments may equally show patterns for 2D coordinate system.

In summary, during or after the machining process of the machine tool 9, the display system 2 and the display method for the same according to the present disclosure employ the design of the fitting unit 21, the calculation unit 22, and the integration unit 23 to trigger path fitting by line number change signals in which G-codes and the position information are converted into corresponding mathematical equations, therefore only a small amount of information is needed for re-drawing the third pattern SL3, AL3 (or a machining path) on the human machine interface 1. Compared to the multi-point path patterns reproduced by the prior art (e.g., fragmented short-segments of straight line or arcs, i.e., the first pattern SL1, ALL PL1), the display system 2 according to the present disclosure is capable of reducing the computational resources required and the memory usage.

With the design of the fitting unit 21, the calculation unit 22, and the integration unit 23, a user only needs to input a tolerance for a third pattern SL3, AL3 (or a machining path) of a desirable configuration (e.g., shifted, zoomed in, zoomed out, etc.) to be displayed on the human machine interface 1 after being processed by the calculation unit 22 and the integration unit 23. Therefore, compared to a jittering multi-point path pattern reproduced by the prior art (e.g., the first pattern SL1, ALL PL1), the third pattern SL3, AL3 displayed by the display system 2 according to the present disclosure allows the user to more easily ascertain the machining status of the machine tool 9 based on the offsets from the original points P shown thereon.

The above embodiments are only used to illustrate the principles of the present disclosure, and should not be construed as to limit the present disclosure in any way. The above embodiments can be modified by those with ordinary skill in the art without departing from the scope of the present disclosure as defined in the following appended claims.

What is claimed is:

1. A display system for a controller of a machine tool, the display system comprising:
a fitting unit configured for converting a position information into a fitting parameter, constructing a first pattern from the position information, and constructing a second pattern from the fitting parameter;
a calculation unit configured for calculating an offset information between the first pattern and the second pattern; and
an integration unit configured for integrating the fitting parameter from the fitting unit and the offset information from the calculation unit into a reference information and constructing a third pattern from the reference information.

2. The display system of claim 1, wherein the position information includes a plurality of path points, G-Codes of NC Program, and line numbers of NC program.

3. The display system of claim 2, wherein the fitting unit is configured for constructing the first pattern from the path points.

4. The display system of claim 2, wherein the fitting unit is configured for constructing the second pattern from the type of the programming code and the path points, and wherein the type of the programming code includes a polyline, a straight line, and an arc.

5. The display system of claim 1, wherein the offset information includes one or more groups of deviation information of the first pattern relative to the second pattern, and each of the groups of deviation information includes at least an offset point, a start fitting projective point, and an end fitting projective point.

6. The display system of claim 1, further comprising a data collection unit configured for retrieving the position information from the controller and transmitting the position information to the fitting unit.

7. The display system of claim 1, further comprising a drawing unit configured for receiving the reference information from the integration unit to draw the third pattern.

8. A display method for a controller of a machine tool, comprising:
converting, by a fitting unit, a position information into a fitting parameter;
constructing, by the fitting unit, a first pattern from the position information;
constructing, by the fitting unit, a second pattern from the fitting parameter;
calculating, by a calculation unit, an offset information between the first pattern and the second pattern;
integrating, by an integration unit, the fitting parameter and the offset information into a reference information; and
constructing, by the integration unit, a third pattern from the reference information.

9. The display method of claim 8, wherein the position information includes a plurality of path points, a type of a programming code, and line numbers of NC program.

10. The display method of claim 9, further comprising constructing, by the fitting unit, the first pattern from the path points.

11. The display method of claim 9, further comprising constructing, by the fitting unit, the second pattern from the type of the programming code and the path points, wherein the type of the programming code includes a polyline, a straight line, and an arc.

12. The display method of claim 8, wherein the offset information includes one or more groups of deviation information of the first pattern relative to the second pattern, and wherein each of the groups of deviation information includes at least an offset point, a start fitting projective point, and a fitting projective point.

13. The display method of claim 8, further comprising retrieving, by a data collection unit, the position information from the controller, and transmitting, by the data collection unit, the position information to the fitting unit.

14. The display method of claim 8, further comprising receiving, by a drawing unit, the reference information from the integration unit to draw the third pattern.
